(19) United States
(12) Patent Application Publication
(10) Pub. No.: US 2025/0392070 A1
(43) Pub. Date: Dec. 25, 2025

(54) CARD CONNECTOR

(71) Applicant: Chiun Hui Technology Co.,Ltd., New Taipei City (TW)

(72) Inventor: Shu-Chu KUNG, New Taipei City (TW)

(21) Appl. No.: 18/968,100

(22) Filed: Dec. 4, 2024

Related U.S. Application Data
(63) Continuation-in-part of application No. 18/753,496, filed on Jun. 25, 2024.

(51) Int. Cl. H01R 13/502; H01R 13/639

(52) U.S. Cl. CPC H01R 13/502; H01R 13/639

(57) ABSTRACT

A card connector includes an insulating base providing an accommodating space, a terminal set, a pushing device, a first side arm with a storage slot on one side, a second side arm with a fixed protruding portion on the other side, and a shell covering the insulating base and having two locking devices respectively provided with an elastic arm extended downward in a curved manner and buckled into one respective storage slot, and each elastic arm being provided with a protruding portion protruding inward. A preset card holder with preset electronic card installed therein is pushed into the accommodating space, so that the preset electronic card is at the position corresponding to the locking devices and the fixed protruding portion for the elastic arms and the fixed protruding portion to synchronously locate and correct the positions of two sides of the preset card holder to avoid deviation.

### CROSS REFERENCE TO THE RELATED APPLICATIONS

This application is a Continuation-In-Part of application Ser. No. 18/753,496, filed on Jun. 25, 2024, for which priority is claimed under 35 U.S.C. § 120, the entire contents of which are hereby incorporated by reference.

### BACKGROUND OF THE INVENTION

### 1. Field of the Invention

The invention relates to a card connector, in particular to a shell covering an insulating base with locking devices on both sides, so that the preset card holder cooperates with the locking devices on both sides of the shell to form a position while maintaining the balance on both sides, thereby achieving the effect of correcting the position of the preset card holder from being deviated to the left or right.

### 2. Description of the Related Art

With the advancement of technology today, electronic products, especially mobile devices such as smartphones, tablets, laptops, and digital cameras have been widely integrated into people's lives. Moreover, these products produced by different manufacturers and brands also have different transmission and storage devices, and thus require various connectors to connect the devices.

Today's various mobile devices also use external electronic cards to expand memory capacity and store more data, files or applications such as multimedia memory cards (MMC), secure digital cards (SD), smart media cards (SM), compressed flash cards (CE), memory cards (MS), electronic chip cards or subscriber function identification cards (SIM), etc. The connectors used in various mobile devices and electronic devices provide a relatively stable plug-in environment to avoid the deviation of the electronic cards during contact, thereby causing unstable connections. This is the key point that those engaged in this industry urgently want to study and improve.

### SUMMARY OF THE INVENTION

Therefore, in view of the above problems and deficiencies, the inventor collected relevant information, evaluated and considered from various parties, and based on years of experience accumulated in this industry, through continuous trials and revisions, to design this card connector.

It is therefore the main object of the present invention to provide a card connector, which comprises an insulating base and a shell. The insulating base comprises an accommodating space inside, a terminal set set therein, a pushing device assembled on at least one side therein and two side arms respectively extended from two opposite lateral sides thereof. Each said side arm is provided with a storage slot. The shell covers the insulating base, comprising two locking devices respectively provided at two opposite lateral sides thereof corresponding to the storage slots of the two side arms. Each locking device comprises an elastic arm extended downward in a curved manner and buckled into one respective storage slot. The elastic arm is provided with a protruding portion protruding inward. The insulating base is provided with a preset card holder for installing a preset electronic card. The preset card holder is pushed into the accommodating space, so that the preset electronic card installed in the preset card holder is placed at the position corresponding to the locking devices for the elastic arms to synchronously locate and correct the positions of two sides of the preset card holder from being deviated to the left or right.

Another object of the present invention is to provide a card connector, which comprises an insulating base and a shell. The insulating base comprises an accommodating space inside, a terminal set set therein, a pushing device assembled on at least one side therein and two side arms respectively extended from two opposite lateral sides thereof. One side arm is provided with a storage slot. The other side arm is provided with a fixed protruding portion protruding inwardly toward the accommodating space. The shell covers the insulating base, comprising a locking device respectively provided at one side thereof corresponding to the storage slot of the side arm. The locking device comprises an elastic arm extended downward in a curved manner and buckled into the storage slot. The elastic arm is provided with a protruding portion protruding inward. The insulating base is provided with a preset card holder for installing a preset electronic card. The preset card holder is pushed into the accommodating space, so that the preset electronic card installed in the preset card holder is placed at the position corresponding to the locking device and the fixed protruding portion for the elastic arm and the fixed protruding portion to synchronously locate and correct the positions of two sides of the preset card holder from being deviated to the left or right.

Still another object of the present invention is that the two ends of each elastic arm of the insulating base are connected to the shell by a folded end portion. Thereby, the outward movement of the elastic arm is reduced, so as to reduce the left and right movement of the preset card holder when it is pushed into the accommodating space. It achieves the purpose of reducing elastic fatigue of the elastic arm due to frequent movements.

Still another object of the present invention is that the insulating base comprises at least one fixed column provided at a rear side thereof; the pushing device comprises a connecting rod and a push rod. The connecting rod comprises at least one fixing hole sleeved on the at least one fixed column to form a positioning, a resisting portion extended from one end thereof, a resisting surface formed on one side of the resisting portion facing the accommodating space, a push surface extended obliquely at a distal end of the resisting portion adjacent to the resisting surface, a positioning portion extended from an opposite end thereof in a curved manner and an inwardly curved abutment surface formed on one side of the positioning portion facing the accommodating space. The push rod comprises a positioning groove provided on one end thereof for assembly of the positioning portion, a J-shaped pushing portion extended from an opposite end thereof, a pushing surface formed on the J-shaped pushing portion, and a pushing groove located on the pushing surface.

Still another object of the present invention is that the push rod of the pushing device further comprises a limiting block; the shell further comprises a limiting groove provided on the surface thereof corresponding to the position of the limiting block of the push rod and larger than the limiting block.

Still another object of the present invention is that each side arm of the insulating base is provided with a plurality of first positioning protrusions on an outer wall thereof; the shell further comprises two first peripheral walls respectively bent and extended on two opposite lateral sides thereof, and a plurality of first positioning holes respectively located on the two first peripheral walls corresponding to the first positioning protrusions of the side arms of the insulating base.

Still another object of the present invention is that the insulating base further comprises a plurality of second positioning protrusions provided on an outer wall thereof; the shell further comprises a second peripheral wall provided between the two first peripheral walls, and a plurality of second positioning holes respectively located on the second peripheral wall corresponding to the second positioning protrusions of the insulating base.

### BRIEF DESCRIPTION OF THE DRAWINGS

FIG. 1 is a three-dimensional appearance view of the card connector of the present invention.

FIG. 2 is a three-dimensional exploded view of the card connector of the present invention.

FIG. 3 is a three-dimensional exploded view of the card connector of the present invention from another perspective.

FIG. 4 is a schematic assembly diagram of the insulating base of the card connector of the present invention.

FIG. 5 is a schematic assembly diagram of the insulating base of the card connector of the present invention from another perspective.

FIG. 6 is a top cross-sectional view of the card entry of the card connector of the present invention.

FIG. 7 is a top cross-sectional view of the card connector of the present invention when the card is withdrawn.

FIG. 8 is a three-dimensional exploded view of another embodiment of the card connector of the present invention.

### DETAILED DESCRIPTION OF THE PREFERRED EMBODIMENT

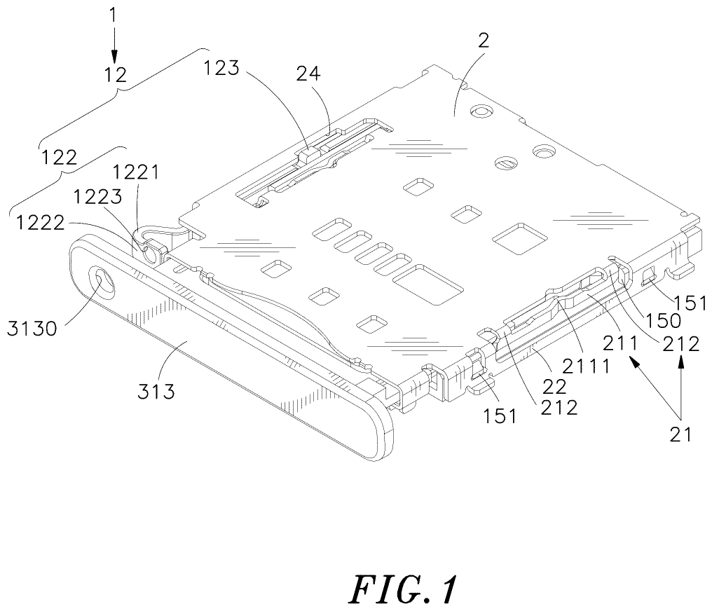

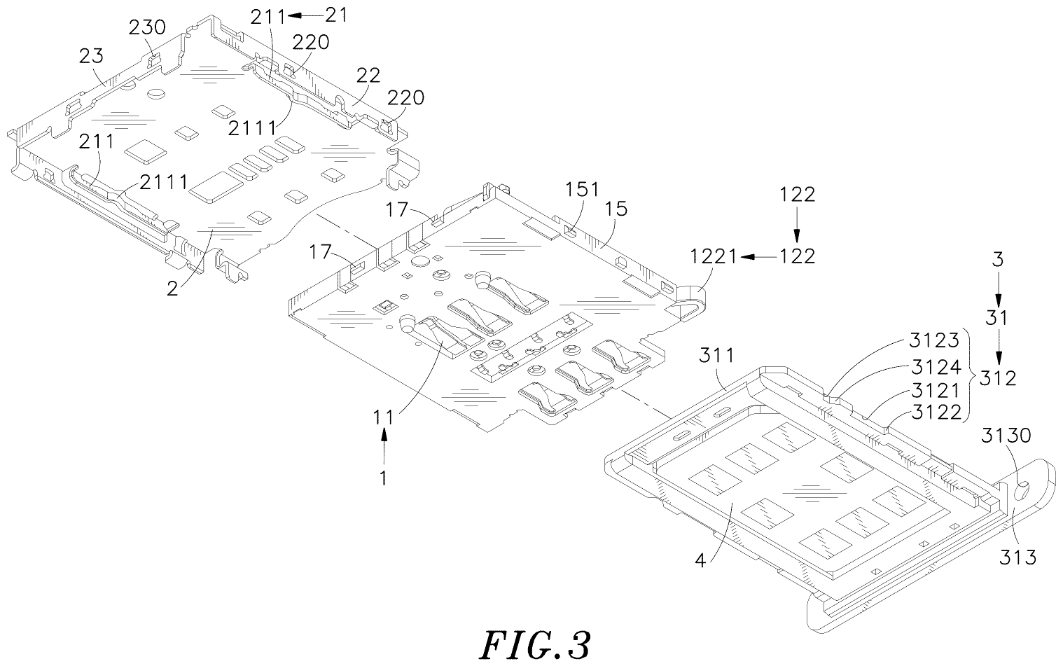

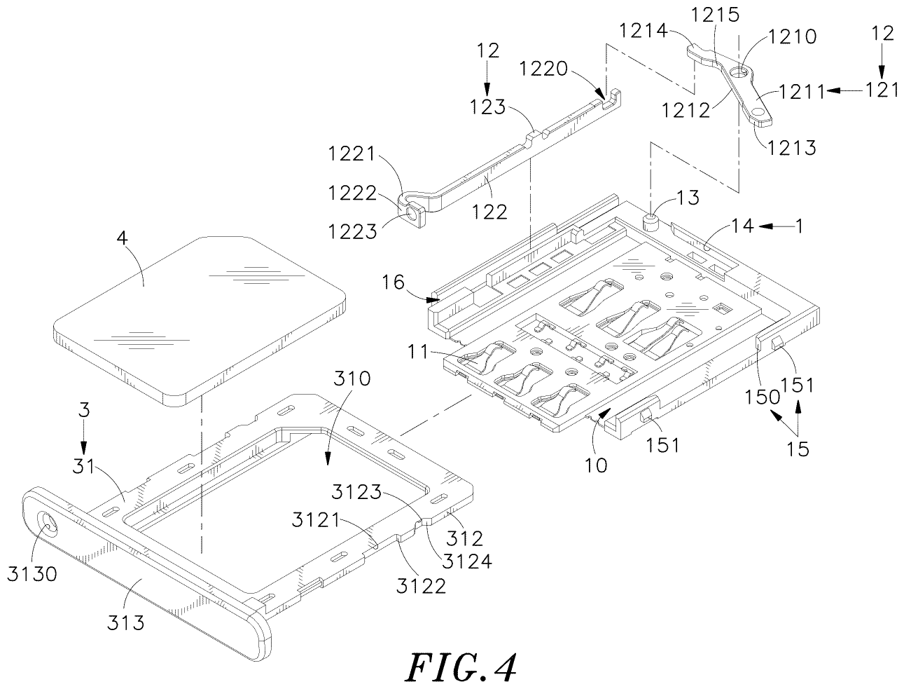

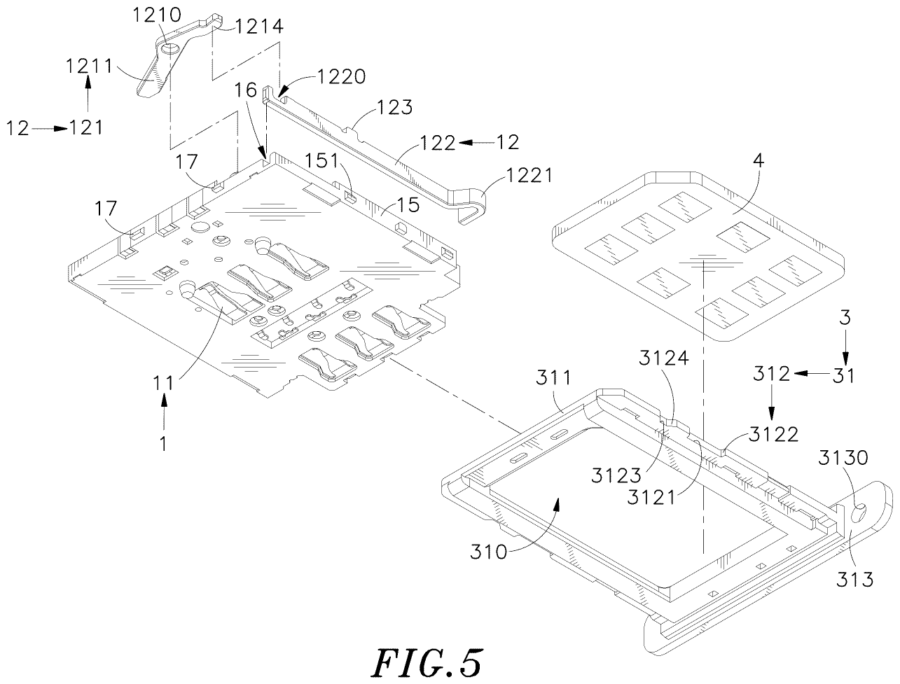

Please refer to FIGS. 1-5, which are three-dimensional appearance view of the card connector of the present invention, three-dimensional exploded view of the card connector of the present invention, three-dimensional exploded view of the card connector of the present invention from another perspective, schematic assembly diagram of the insulating base of the card connector of the present invention and schematic assembly diagram of the insulating base of the card connector of the present invention from another perspective. The card connector of the present invention mainly comprises an insulating base 1 and a shell 2, and the connection relationship between the aforementioned components is as follows:

The insulating base 1 comprises an accommodating space 10 inside, a terminal set 11 set therein, a fixed column 13 provided at a rear side thereof, at least one pushing device 12 mounted on the fixed column 13, a storage space 14 recessed therein adjacent to one side of the fixed column 13, two side arms 15 extended from two opposite lateral sides thereof, each side arm 15 being provided with a storage slot 150 in the middle and a plurality of first positioning protrusions 151 on the outer wall at two opposite lateral sides of the two side arms 15, a sliding channel 16 provided on at least one lateral side of the insulating base 1 for a push rod 122 of the pushing device 12 to slide, and a plurality of second positioning protrusions 17 provided on the outer wall at the rear side of the insulating base 1.

The pushing device 12 comprises a connecting rod 121 and the aforementioned push rod 122. The connecting rod 121 comprises a fixing hole 1210 that is sleeved on the fixed column 13 to form a positioning, a resisting portion 1211 extended from one end thereof and located in the storage space 14, a resisting surface 1212 formed on one side of the resisting portion 1211 facing the accommodating space 10, a push surface 1213 extended obliquely at a distal end of the resisting portion 1211 adjacent to the resisting surface 1212, a positioning portion 1214 extended from an opposite end thereof in a curved manner, and an inwardly curved abutment surface 1215 formed on one side of the positioning portion 1214 facing the accommodating space 10. The push rod 122 comprises a positioning groove 1220 provided on one end thereof for assembly of the positioning portion 1214, a J-shaped pushing portion 1221 extended from an opposite end thereof, a pushing surface 1222 formed on the J-shaped pushing portion 1221, a pushing groove 1223 located on the pushing surface 1222, and a limiting block 123 protruded from the push rod 122 and located between the positioning groove 1220 and the J-shaped pushing portion 1221.

The shell 2 covers the insulating base 1. The shell 2 comprises two locking devices 21 respectively provided at two opposite lateral sides thereof corresponding to the storage slots 150, two first peripheral walls 22 respectively bent and extended on two opposite lateral sides thereof, a plurality of first positioning holes 220 respectively located on the two first peripheral walls 22 corresponding to the first positioning protrusions 151, a second peripheral wall 23 provided between the two first peripheral walls 22, a plurality of second positioning holes 230 respectively located on the second peripheral wall 23 corresponding to the second positioning protrusions 17 of the insulating base 1, and a limiting groove 24 provided on the surface of the shell 2 corresponding to the position of the limiting block 123 of the push rod 122 and larger than the limiting block 123. Each locking device 21 comprises an elastic arm 211 that has two folded end portions 212 connected to the shell 2 so that the elastic arm 211 is extended downward in a curved manner and buckled into each storage slot 150. Each elastic arm 211 is further provided with a protruding portion 2111 protruding inward.

The card connector of the present invention is further assembled with a preset card holder 3. The preset card holder 3 comprises a holder main body 31, a receiving slot 310 formed in the holder main body 31 for receiving a preset electronic card 4 (such as a secure digital card, a memory card or an identification card, etc.), a supporting wall 311 located on one side of the holder main body 31 facing the insulating base 1, a first recess 3121 provided on each of two opposite side edges 312 extended from the supporting wall 311, a vertical wall surface 3122 located on each of two opposite sides of each of the first recesses 3121, a second recess 3123 located between the supporting wall 311 and each of the first recesses 3121, two inclined angled wall surfaces 3124 respectively located on two opposite sides of each of the second recesses 3123, a force applying portion 313 provided on a rear side of the holder main body 31 opposite to the supporting wall 311, and a through hole 3130 located on the force applying portion 313 and aligned with the pushing groove 1223.

Furthermore, when the present invention is to be made into a structure, the terminal set 11 is first molded into the insulating base 1 by insert molding, and then the fixing hole 1210 of the connecting rod 121 of the pushing device 12 is sleeved onto the fixed column 13 provided on the insulating base 1 for fixing, so that the resisting portion 1211 provided on one side of the connecting rod 121 will be located in the storage space 14 of the insulating base 1, and the push rod 122 of the pushing device 12 will be located in the sliding channel 16 of the insulating base 1, and the positioning groove 1220 on one side of the push rod 122 adjacent to the connecting rod 121 is for the positioning portion 1214 of the connecting rod 121 to be stored and positioned. The shell 2 is then covered the insulating base 1, so that the first positioning holes 220 of the first peripheral walls 22 on two opposite lateral sides of the shell 2 are respectively sleeved onto the first positioning protrusions 151 outside the insulating base 1, and the second positioning holes 230 on the second peripheral wall 23 of the shell 2 are respectively sleeved onto the second positioning protrusions 17 outside the insulating base 1, and the locking devices 21 located on two opposite lateral sides of the shell 2 are buckled into the storage slots 150 of the side arms 15 corresponding to both sides of the insulating base 1. Then the preset electronic card 4 is assembled in the receiving slot 310 of the holder main body 31 of the preset card holder 3. By applying force to the force applying portion 313 of the preset card holder 3 and pushing it inward, so that the holder main body 31 of the preset card holder 3 is pushed into the accommodating space 10 of the insulating base 1. This completes the overall structure of the card connector of the present invention.

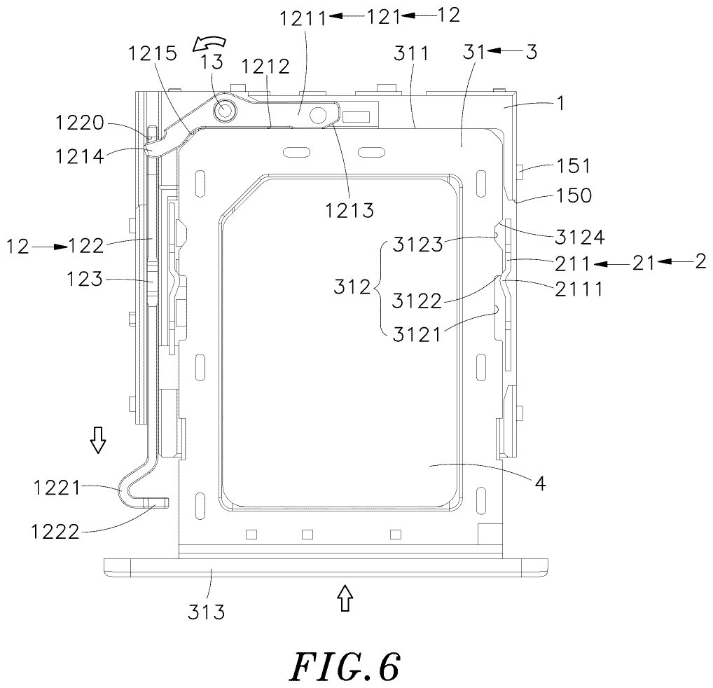

Please refer to FIGS. 1, 6 and 7, which are three-dimensional appearance view of the card connector of the present invention, top cross-sectional view of the card entry of the card connector of the present invention and top cross-sectional view of the card connector of the present invention when the card is withdrawn. It can be clearly seen from the figures that in order to push the preset card holder 3 in for fixing, the supporting wall 311 of the holder main body 31 of the preset card holder 3 can be pushed in and resisted against the resisting surface 1212 of the resisting portion 1211 of the connecting rod 121, so that the connecting rod 121 can be pushed into the storage space 14, and the positioning portion 1214 extending from one end of the connecting rod 121 in a curved manner pushes the inner wall surface of the positioning groove 1220 of the push rod 122 outward by the thrust, so as to push the push rod 122 to move outward a distance by the thrust of the positioning portion 1214, and the limiting block 123 provided on the push rod 122 is limited to the limiting groove 24 of the shell 2 and will not move outward excessively. At the same time, as the preset card holder 3 is pushed in, the protruding portions 2111 protruding from the elastic arms 211 on both sides of the shell 2 will pass through the respective second recesses 3123 and extend into the respective first recesses 3121. The inclined angled wall surfaces 3124 on two opposite sides of each of the second recesses 3123 are inclined, which allows the protruding portions 2111 to move more easily without being positioned. The vertical wall surfaces 3122 of the first recesses 3121 are respectively held by the protruding portions 2111 on both sides of the shell 2 and will not exit, so that the preset card holder 3 cooperates with the locking devices 21 on both sides of the shell 2 to form a positioning. At the same time, the balance of both sides is maintained to achieve the effect of correcting the position of the preset card holder 3 to avoid deviation.

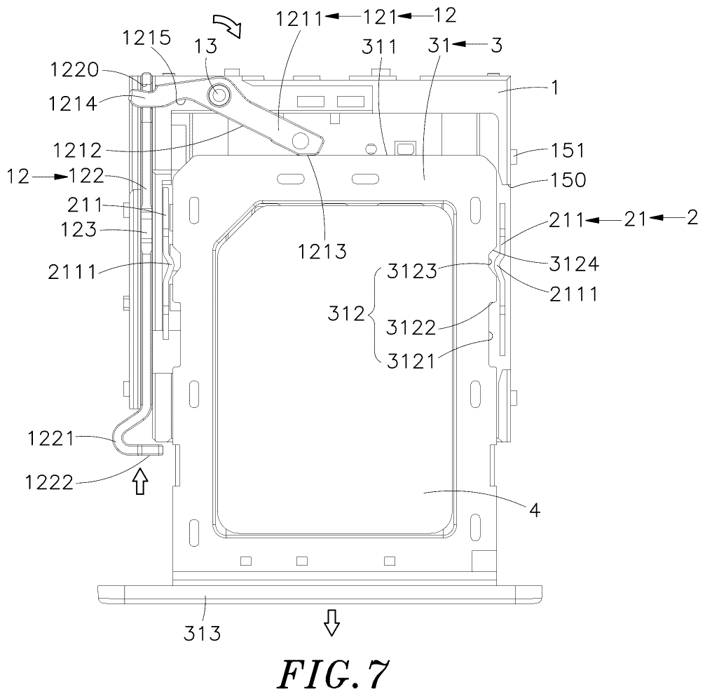

If you want to exit the preset card holder 3, you can push the pushing surface 1222 of the J-shaped pushing portion 1221 of the push rod 122, so that the push rod 122 can slide inward along the sliding channel 16 to cause the positioning portion 1214 of the connecting rod 121 in the positioning groove 1220 of the push rod 122 to be tilted outward by the thrust of the push rod 122. And the push surface 1213 of the push rod 122 will tilt outward at an angle and then push against the surface of the supporting wall 311 of the preset card holder 3, and push the preset card holder 3 outward a distance. Then, the protruding portions 2111 originally located in the first recesses 3121 are displaced into the second recesses 3123 as the preset card holder 3 is pushed outward (as shown in FIG. 7), thereby completing the card entry and exit of the card connector of the present invention.

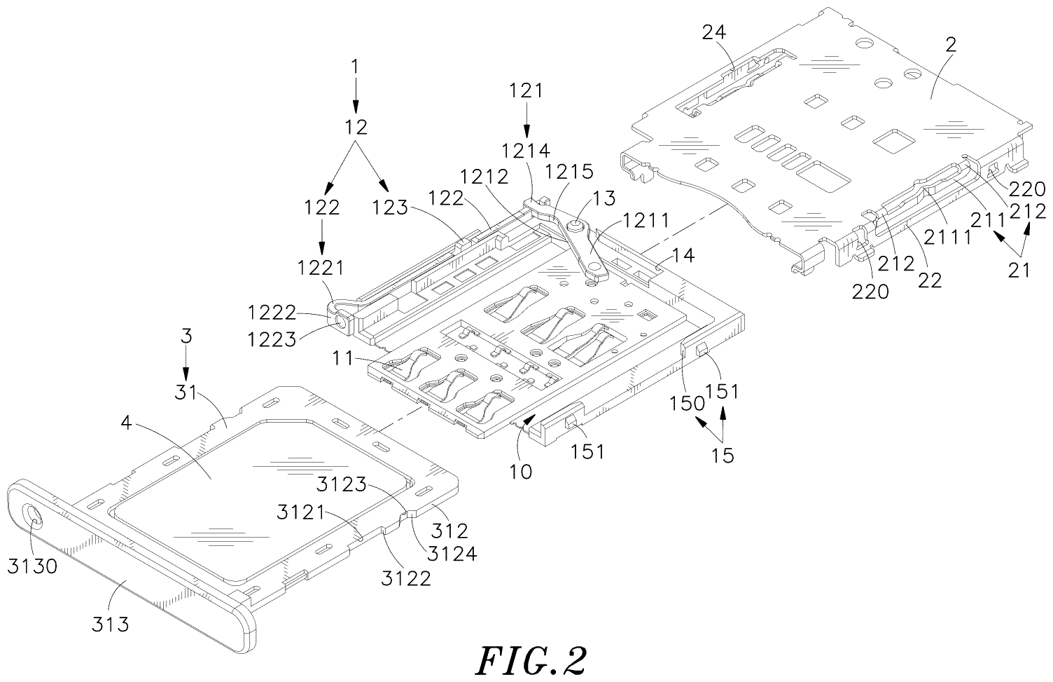

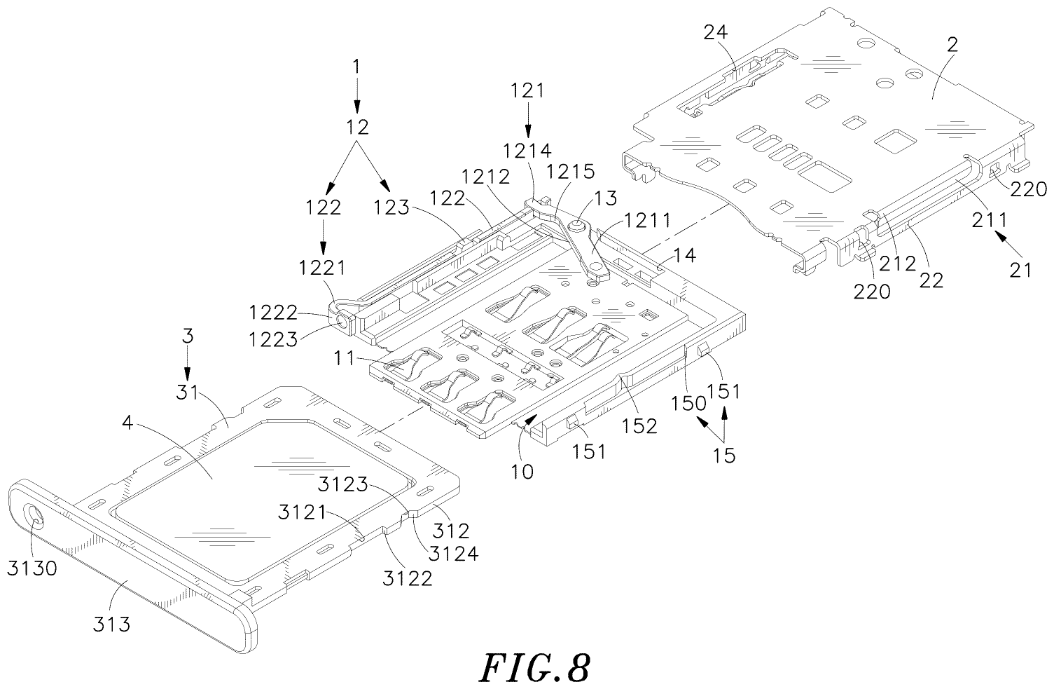

Please continue to refer to FIG. 8, which is a three-dimensional exploded view of another embodiment of the card connector of the present invention. It can be clearly seen from the figure that the structure disclosed in FIG. 8 is similar to the structure in FIG. 2, and the difference is that a fixed protruding portion 152 is protruded from the side arm 15 extending from one side of the insulating base 1 to replace the position of the storage slot 150. The fixed protruding portion 152 cooperates with the elastic arm 211 correspondingly buckled into the storage slot 150 on the other side to elastically position the two side edges 312 of the preset card holder 3 and correct the position of the preset card holder 3 to avoid deviation. The remaining structures disclosed in this embodiment are the same as those in FIG. 2, and thus will not be repeated here.

In addition, the above-mentioned preset card holder 3 can further push the pushing groove 1223 on the pushing surface 1222 of the pushing rod 122 by passing the shank of a screwdriver through the through hole 3130 on the surface of the force applying portion 313, thereby achieving the effect of ejecting the card.

Furthermore, the above-mentioned each elastic arm 211 is connected to the shell 2 through the folded end portions 212 at both ends thereof, thereby reducing the outward movement of the elastic arm 211. This reduces the left and right movement of the preset card holder 3 when it is pushed into the accommodating space 10, and further achieves the purpose of reducing the elastic fatigue of the elastic arm 211 due to frequent movements.

In addition, the present invention is mainly directed to the insulating base 1 having at least one pushing device 12 inside, and the insulating base 1 being covered by the shell 2 having the locking devices 21 on both sides. The main feature is that when the preset card holder 3 is pushed in, it can cooperate with the locking devices 21 on both sides for positioning and correct the left and right positions of the preset card holder 3 at the same time to avoid deviation. Another feature is that each elastic arm 211 is connected to the shell 2 through the folded end portions 212 at both ends thereof to reduce the outward movement of the elastic arm 211, thereby reducing the left and right movement of the preset card holder 3 when it is pushed into the accommodating space 10, and then achieving the purpose of reducing the elastic fatigue of the elastic arm 211 due to frequent movements.

The above descriptions are only preferred embodiments of the present invention, and do not limit the patent scope of the present invention. Therefore, all simple modifications and equivalent structural changes made by using the contents of the description and drawings of the present invention shall be included in the patent scope of the present invention and shall be clearly stated.

To sum up, the card connector of the present invention can indeed achieve its efficacy and purpose when it is used. Therefore, the present invention is an invention with excellent practicability and meets the application requirements for an invention patent. I would like to file an application in accordance with the law, and hope that the review committee will approve the application as soon as possible to protect the inventor's hard work. If there is any doubt from the review committee of the Bureau, please do not hesitate to send a letter to instruct, and the inventor will do his best to cooperate.

What the invention claimed is:

1. A card connector, comprising an insulating base and a shell, wherein:
said insulating base comprises an accommodating space inside, a terminal set set therein, a pushing device assembled on at least one side therein and two side arms respectively extended from two opposite lateral sides thereof, each said side arm being provided with a storage slot;
said shell covers said insulating base, said shell comprising two locking devices respectively provided at two opposite lateral sides thereof corresponding to said storage slots of two said side arms, each said locking device comprising an elastic arm extended downward in a curved manner and buckled into each said storage slot, said elastic arm being provided with a protruding portion protruding inward; and
wherein said insulating base is provided with a preset card holder for installing a preset electronic card, said preset card holder being pushed into said accommodating space, so that said preset electronic card installed in said preset card holder is placed at the position corresponding to said locking devices for said elastic arms to synchronously locate and correct the positions of two sides of said preset card holder to avoid deviation.

2. The card connector as claimed in claim 1, wherein said insulating base comprises at least one fixed column provided at a rear side thereof; said pushing device comprises a connecting rod and a push rod, said connecting rod comprising a fixing hole sleeved on said at least one fixed column to form a positioning, a resisting portion extended from one end thereof, a resisting surface formed on one side of said resisting portion facing said accommodating space, a push surface extended obliquely at a distal end of said resisting portion adjacent to said resisting surface, a positioning portion extended from an opposite end thereof in a curved manner and an inwardly curved abutment surface formed on one side of said positioning portion facing said accommodating space, said push rod comprising a positioning groove provided on one end thereof for assembly of said positioning portion, a J-shaped pushing portion extended from an opposite end thereof, a pushing surface formed on said J-shaped pushing portion and a pushing groove located on said pushing surface.

3. The card connector as claimed in claim 2, wherein said push rod of said pushing device further comprises a limiting block; said shell further comprises a limiting groove provided on the surface thereof corresponding to the position of said limiting block of said push rod and larger than said limiting block; said insulating base further comprises a storage space recessed therein adjacent to said at least one fixed column for receiving said resisting portion, and a sliding channel provided on at least one side thereof for said push rod to slide.

4. The card connector as claimed in claim 1, wherein each said side arm of said insulating base is provided with a plurality of first positioning protrusions on an outer wall thereof; said shell further comprises two first peripheral walls respectively bent and extended on two opposite lateral sides thereof, and a plurality of first positioning holes respectively located on said two first peripheral walls corresponding to said first positioning protrusions of said side arms of said insulating base.

5. The card connector as claimed in claim 4, wherein said insulating base further comprises a plurality of second positioning protrusions provided on an outer wall thereof; said shell further comprises a second peripheral wall provided between said two first peripheral walls, and a plurality of second positioning holes respectively located on said second peripheral wall corresponding to said second positioning protrusions of said insulating base.

6. The card connector as claimed in claim 1, wherein each said elastic arm of said insulating base comprises two folded end portions respectively extended from two opposite ends thereof and connected to said shell.

7. A card connector, comprising an insulating base and a shell, wherein:
said insulating base comprises an accommodating space inside, a terminal set set therein, a pushing device assembled on at least one side therein and two side arms respectively extended from two opposite lateral sides thereof, one said side arm being provided with a storage slot, the other said side arm being provided with a fixed protruding portion protruding inwardly toward said accommodating space;
said shell covers said insulating base, said shell comprising a locking device provided at one side thereof corresponding to said storage slot of said side arm, said locking device comprising an elastic arm extended downward in a curved manner and buckled into said storage slot, said elastic arm being provided with a protruding portion protruding inward; and
wherein said insulating base is provided with a preset card holder for installing a preset electronic card, said preset card holder being pushed into said accommodating space, so that said preset electronic card installed in said preset card holder is placed at the position corresponding to said locking device and said fixed protruding portion for said elastic arm and said fixed protruding portion to synchronously locate and correct the positions of two sides of said preset card holder to avoid deviation.
